(19) United States
(12) Patent Application Publication
(10) Pub. No.: US 2009/0236004 A1
(43) Pub. Date: Sep. 24, 2009

(54) SMOOTH AND FLEXIBLE CLEAN ROOM HOSE

(76) Inventors: Bhargav Jani, Corona, CA (US); Arun Shah, Anaheim, CA (US)

Correspondence Address: JOHN MOLNAR JR., PARKER-HANNIFIN CORPORATION, 6035 PARKLAND BOULEVARD, CLEVELAND, OH, 44124-4141, US

(21) Appl. No.: 12/417,123

(22) Filed: Apr. 2, 2009

Related U.S. Application Data
(62) Division of application No. 11/156,194, filed on Jun. 16, 2005, now abandoned.

(51) Int. Cl. F16L 11/08; F16L 11/02

(52) U.S. Cl. 138/127; 138/137; 138/141; 138/125; 138/130

(57) ABSTRACT

A hose suited for use in clean rooms has a Minimum Bend Radius (MBR) that is flexible without kinking. The hose includes a germ and bacteria resistant smooth outer surface and is constructed form a low modulus rubber type matrix with primary reinforcement layers laid at optimal opposing angles around a thin walled thermoplastic liner and similarly a secondary reinforcement layer of wire is utilized.

### CROSS-REFERENCE TO RELATED APPLICATIONS

The present application is a divisional of U.S. patent application Ser. No. 11/156,194, filed Jun. 16, 2005, the disclosure of which is expressly incorporated herein by reference.

### BACKGROUND OF THE INVENTION

The presented invention relates to hybrid hoses, particularly laminates of poly-fluorocarbon liner with carbon based or non carbon based rubber subcomponents which embodies reinforcing components like smaller gauge dual steel helical wire and textile polyester yarn, braid or tire-cord reinforcements. The reinforcements are embedded in a single homogeneous rubber matrix which is designed to have high strength and resilience but low modulus which provide unique and desirable combinations of cost effective light weight product, high flexibility, lower force to bend, dimensional stability under pressure and offers outer and inner surfaces which are free from pockets, kinks and folds, smooth and glossy, hydrophobic, easy to clean and maintain, prevent and resist the growth of bacteria and microbes to make this hose suitable for clean room environment in food, bio pharmaceutical industry or any other industry.

Manufacturing know-how and existing art for industrial hoses are well established, well documented and can be implemented by the user of this art in the following general areas:

Extrusion of poly-fluorocarbon thermo-plastic liners for outstanding chemical and heat resistance, external etching processes on such liners for achieving adhesion, bonding resin based cements for achieving optimal adhesion, calendaring of carbon and non-carbon based rubbers as thin sheets, application and fabrication of rubber, reinforcement of textile yarn, braid or tire-cord, and wire components on steel mandrels using automatic, semi-automatic or hand build processes, heat shrinkable nylon wrap for cure, autoclave open steam cure and the supporting technology for above processes. Current art utilizes designs using poly-fluorocarbon thermoplastics thin wall or thick wall, singularly or in combination with rubber components, smooth inner rubber tube, convoluted thermoplastic liner, smooth but non-cleanable outer rubber or non-cleanable corrugated outer rubber or thermoplastic cover.

### SUMMARY OF THE INVENTION

The present inventors have realized the need for easily cleaned hoses particularly in clean room environments that are easily bent without kinking and/or deformations.

The present invention provides a Food, Biological and Pharmaceutical grade poly-fluorocarbon thermoplastic lined rubber covered hybrid suction hose which is designed to provide a sanitary hose for use in clean room in-plant or in-situ environment or bulk transfer of materials for clean room processing, which is thin walled, extremely flexible, light in weight, needs less force to bend to smaller radii without kinking and deformation, which is ergonomically friendly and safe for handlers and end users. This invention provides a smooth, glossy, slippery, molded outer cover surface appearance that is easily cleanable and also utilizes smooth easily cleanable thin poly-fluorocarbon thermoplastic inner liner tube. All above stated valuable features and attributes are highly desirable and beneficial to this industry and all of which provide solutions to the current problems and challenges faced by the Food/Bio/Pharmaceutical applications.

The present invention is also applicable as an industrial hose in various industries like Petroleum products, chemical products, processed water, and other specialty and general purpose applications where sanitary standards may not be stringent but nevertheless a flexible, light weight, cost effective poly-fluorocarbon thermoplastic hose product is required for an in plant, in-site or bulk transfer applications for various chemicals and materials. The present invention offers better options and will replace current rigid, non-flexible, heavy, expensive, unsafe and unreliable common hose products commercially available in the market place. The innovative use of designs and materials in the present invention provides features and benefits which are described in detail below. The present invention includes imparting smooth shiny, slippery cover surface that denies development sanitary for microbes, bacteria, and the like. The smooth surface results in an externally aesthetic, smooth, and glossy rubber outer surface.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing providing a layered telescopic view of the multiple-layered hose according to various embodiments of the present invention;

FIG. 2 is a drawing that illustrates the flexibility feature of a hose according to embodiments of the present invention in the context of a Minimum Bend Radius (MBR) and force F1 to bend the hose from 90-degree position and F2 for 180 degree relative to normal horizontal position of the hose; and

FIG. 3 is a drawing of an example dual helical reinforcement line according to an embodiment of the present invention.

### DETAILED DESCRIPTION OF THE INVENTION

In one embodiment, the present invention provides hybrid poly-fluorocarbon liners with elastomeric rubber which offers smooth, slippery inner liner and shiny, glossy outer hose surfaces which are aesthetic, both easily cleanable, are hydrophobic, prevents bacterial and microbial growth, and are safe to use and maintain in clean room environment typically required in Food, Bio-pharmaceutical, and other industries. One aspect of this invention is to provide cost effective, super flexible hose which can be flexed at extremely tight bend radii and can be handled with least human effort with safety, without damaging or kinking the hose at small bend radii, which does not stretch the thin thermoplastic liner when flexed or when under pressure. Due to designed feature of this hose, length stability of hose under pressure is achieved which prevents liner stretching and formation of unacceptable folds and kinks when relaxed from pressure. The invention generally relates to multiple aspects comprising clean room safety and reliability, extreme flexibility, ergonomic safety, reliable and extended hose life, versatility in utilizing tight space effectively, cost effective employment, increased laminar flow, ability to make safe and reliable assemblies as well as general improved aesthetics all of which provide solutions to current problems not resolved by current state of the art.

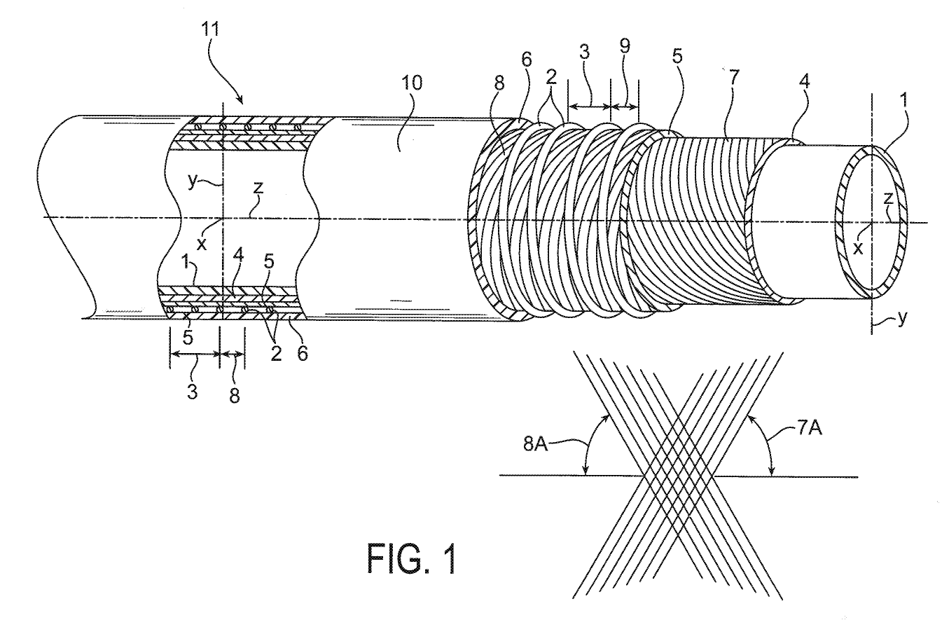

Referring now to the drawings, wherein like reference numerals designate identical or corresponding parts, and more particularly to FIG. 1 thereof, there is illustrated a chemical resistant hose 10 constructed in accordance with an embodiment of the present invention. Elements of the hose and various layers are shown in a telescope in relationship to one another. The hose 10 is particularly well suited for food and Bio-pharmaceutical applications.

An extruded thin walled (0.008 in. to 0.020 in.) poly-fluorocarbon thermoplastic liner 1 is applied in conjunction with the adjoining top layer of elastomeric backing substrate 4 applied spirally or in other suitable manner which serves as an EPDM Ethylene Propylene Diene monomer based adhesive peroxide cured bonding agent, EP-3™ or other bonding agents.

For example, elastomers and bonding agents as disclosed by U.S. Pat. No. 5,300,569 made of a composition of EPDM and other derivatives available to the industry under trade names of RICOBOND™. This adhesive formulation may be modified to suit the processability under manufacturing conditions by imparting necessary green strength property. Next to this layer on the top, a first layer of polyester yarn reinforcement 7 is applied in one direction at a predetermined pitch, no. of yarns per inch, to meet the hose design requirement at a specific angle of lay 7A for a given diameter of the hose. Next, a layer of filler rubber 5 is applied spirally on top of the yarn layer which serves as cushion for the wires applied on top which get embedded in this soft rubber (or EPDM based) matrix.

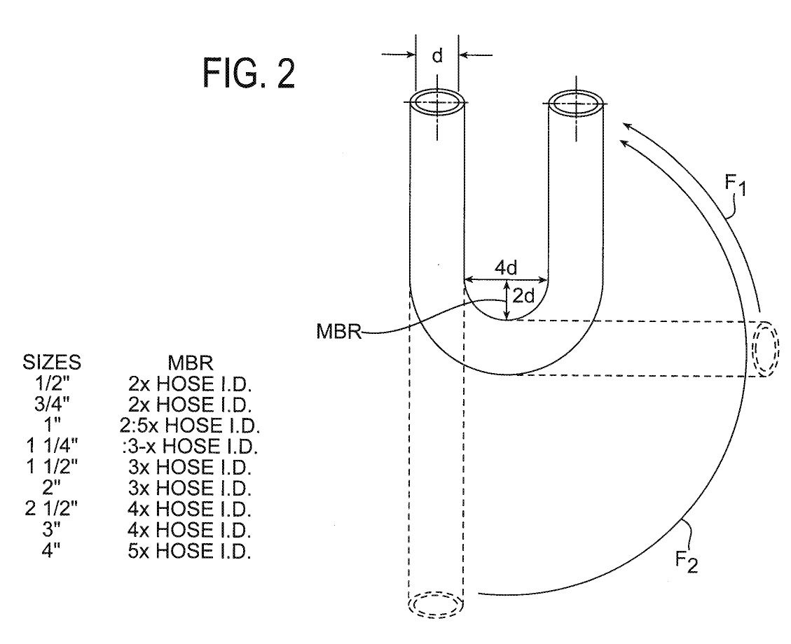

Predetermined smaller gauge dual helical wires 2 being of 0.041 in. to 0.080 in. diameter are both applied at an equidistant pitch 3 of approximately 0.300 in. to 0.600 in. dependent upon hose size so as to produce spacing 9 of approximately 0.150 in. to 0.300 in. The wrapped dual gauge helical wires are designed to adequately embed and support the poly-fluorocarbon thermoplastic liner under it which greatly prevents the hose and/or the liner from kinking when extremely flexed, (note FIG. 2).

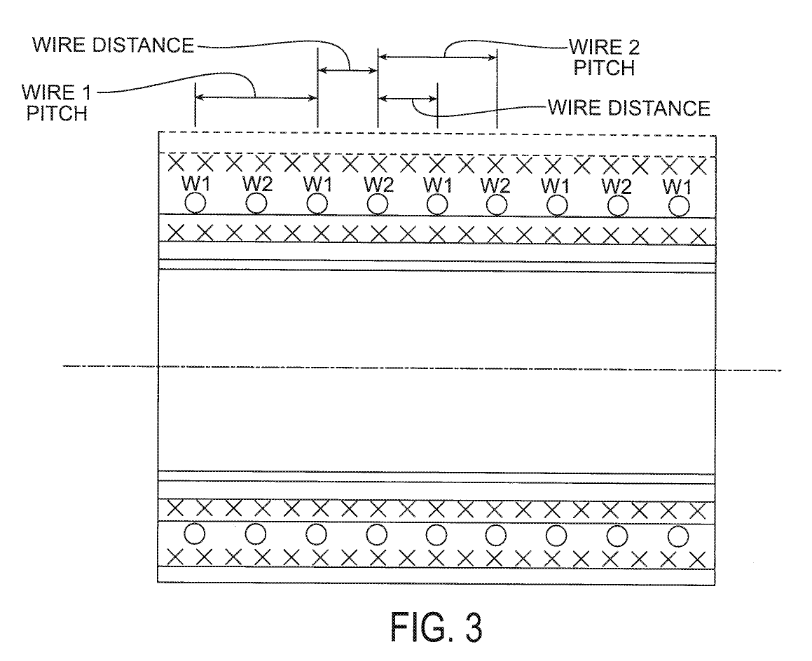

FIG. 3 is a drawing of an example dual helical reinforcement line according to an embodiment of the present invention. The secondary reinforcement line comprises helical small gauge wires of approximately 0.041″ to 0.080″ in diameter applied at pitch ranging approximately 0.300″ to 0.600″ and having a wire spacing of 0.150″-0.300″. The dual helical (helix) wires are constructed, for example, from Carbon steel, stainless steel, monofilament rod, and similar materials. The dual helical wires are, for example, small gauge wires configured at an optimal pitch comprising:

Table for Optimal Wire Size and Pitch Configuration

| | | | | Space Between |
|---|---|---|---|---|
| Hose Diameter | Wire Gauge | Pitch | No. of | Adjoining Wires |
| (in) in | (in) in | (in) in | Wires | (in) in |
| 0.5 | 0.041 | 0.300-0.400 | 2 | 0.150-0.200 |
| 0.75 | 0.041 | 0.300-0.400 | 2 | 0.150-0.200 |
| 1 | 0.041 | 0.300-0.400 | 2 | 0.150-0.200 |
| 1.25 | 0.041 | 0.300-0.400 | 2 | 0.150-0.200 |
| 1.5 | 0.048 | 0.360-0.640 | 2 | 0.180-0.320 |
| 2 | 0.062 | 0.360-0.640 | 2 | 0.180-0.320 |
| 2.5 | 0.062 | 0.360-0.640 | 2 | 0.180-0.320 |
| 3 | 0.080 | 0.500-0.600 | 2 | 0.250-0.300 |
| 4 | 0.092 | 0.500-0.600 | 2 | 0.250-0.300 |

The dual helical wires provide rigidity and support and a strong vacuum suction rating while maintaining flexibility.

A homogeneous, lower modulus EPDM rubber compound as in this embodiment (FIG. 1, note reference numerals 4, 5 and 6) operationally yields modulus of 150-300 lbs tensile strength at 100% elongation used in the entire body of the hose construction as a backing 4, filler 5 and cover 6 materials. The result is a significantly lower force to bend when subjected to much smaller bend radii (MBR) in the magnitude of 2× inside hose diameter to 5× inside hose diameter dependent upon size and embodiment of 2 plies of reinforcement (note chart in FIG. 2)(see Table below for Optimal pitch of reinforcement). And, the present invention provides a lower force to bend F1 and F2 relative to the current state of art designs for 2 ply, 4 ply, or multiples of 2 ply reinforcement which typically range from 5× inside hose diameter to 12× inside hose diameter by incorporating spiral yarn, braided or tire cord reinforcements, which empirically are known to yield 2× to 4× F1 and 2× to 4× F2 force to bend. In the present invention optimally uses a 43-45 degree yarn reinforcement of 2 or more textile yarn plies (note reference numbers 7 and 8) applied spirally and both in opposite direction to each other as shown in FIG. 1 (note reference numerals 7A and 8A). Alternate plies in opposite directions to one another in invention embodiments with multiple plies and using optimal pitch provides a design with greater flexibility and dimensional stability resulting in −1.0 to +1.0% hose elongation under operating working pressure all of which synergistically imparts the desirable properties and solutions discussed herein.

Table for Optimal Pitch of Reinforcement

| Hose Diameter | Optimal Pitch |
|---|---|
| Size (in) | (in) |
| 0.5 | 2.47-2.6 |
| 0.75 | 3.37-3.5 |
| 1 | 3.8-3.95 |
| 1.25 | 4.77-4.82 |
| 1.5 | 5.62-5.65 |
| 2 | 7.18-7.39 |
| 2.5 | 8.58-8.86 |
| 3 | 10.54-10.7 |
| 4 | 14.0-14.35 |

The number of ends per inch is then varied depending on strength requirements of the hose, and is left as a design choice for each specific application of the hose.

The present inventors have realized the value of ergonomic safety and human ease in hose designs. A major consideration in valuation of an industrial hose product and its application is multi-faceted combination of initial cost, subsequent cost, magnitude of weight of the hose, ease of carrying, coiling and bending to smaller diameters, force required to bend and handle hoses without kinking or damaging during manufacturing, warehousing, shipping, fabrication of assemblies and ultimate application of hose assemblies with safety and reliability by the end users. All of above features determine value to the customer in terms of overall cost effectiveness, human ease, ergonomic safety, application safety and efficient utilization of available space.

Current state of the art in designs, materials and manufacturing hose for Food/Bio/Pharmaceutical and other industries employ design parameters and materials, which greatly inhibit or limit desirable weight, flexibility, space requirement, force to bend, and the prevention of potential kink damage. Several poly-fluorocarbon thermoplastic hose liners like FEP, PTFE and similar materials are used in the industry along with rubber and other reinforcing materials which mostly result in a stiff, less flexible, pipe like properties due to high flexural rigidity of the conventional thicker wall poly-fluorocarbon liners and hose constructions.

Current state of the art attempts to resolve the flexibility and force to bend problems and issues by incorporating convolutions in the hose tube or corrugations on the outer cover to make the hose product more flexible. Some manufacturers resort to thin wall poly-fluorocarbon thermoplastic inner liner for rubber covered hoses with external corrugations. Though such design recourse helps in increasing flexibility and reducing weight to some extent for some industrial hose applications like chemical industry which does not require sanitary standards, however such convoluted and/or corrugated profiles are not suitable and not acceptable in Food, Biological and Pharmaceutical applications due to higher and stricter sanitary standards of cleanliness requiring FDA and/or USP class 6 compliance where bacteria or germ free clean room environments are required. Such internal and external designed surface profiles for flexibility have a great potential for providing inner pockets and entrapments that cannot be adequately cleaned and can be potentially dangerous. Current art using this poly-fluorocarbon smooth liners have high susceptibility to develop and retain kinks and folds when hose is under pressure due to stretch of the liner that normally gets elongated up to 7% in length at normal working pressure.

The present invention resolves the above with the hose design embodiments discussed above with reference to FIGS. 1, 2, and 3. The described hose provides attributes and properties of ergonomic safety, human effort and ease, application versatility, product reliability from kink damage, providing and maintaining high sanitary standards at an economic lower cost which are all required for Food/Bio/Pharmaceutical industry and also is beneficial to other industries like chemical transfer. The combination of the low modulus matrix with embedded reinforcements layered in opposite directions at an optimal angle of lay and a thin walled thermoplastic liner provides the needed flexibility and resistance to deformation and kinking whether static or under operating pressure.

The present inventors have also realized the need to meet and exceed current clean room environment and sanitary safety standards. Most hose products that are offered to this industry are either 100% rubber hose, 100% poly-fluorocarbon thermoplastics (FEP, PTFE etc.) or poly-fluorocarbon thermoplastic inner tube with rubber body of backing, filler and cover in addition to textile reinforcements and helical steel wire if required. All such hoses in the industry require FDA compliance. However cleanliness is a major part of the clean room industry specifications and requirements.

100% rubber hoses used in this industry are predominantly silicone type hoses with smooth tube and cover which meet FDA requirements, however the silicone and rubber hoses do not have the clean ability advantage of poly-fluorocarbon thermoplastics since rubber is hydrophilic, naturally attracts and retains foreign materials and the surface finish on such manufactured hoses are not shiny, molded and slippery due to conventional nylon wrap method of curing or open steam flexible mandrel cure.

100% poly-fluorocarbon thermoplastic hoses used in this industry either have a smooth tube with corrugated outer cover or convoluted inner tube with corrugated or smooth (non-corrugated) cover. Again, such hoses that are designed for increased flexibility do not provide safe and reliable clean ability for lack of a smooth, easily cleanable surface either in the inside or outside of the hose which can not be free from wavy pockets of peaks and valleys due to corrugations on the surface or embedded in other parts of the hose.

Current rubber covered poly-fluorocarbon thermoplastic internally smooth tube with corrugated rubber cover or non-corrugated, non-slippery and glossless rubber cover all do not provide ideal surface properties and conditions for clean ability and hygiene for both inner and outer hose surfaces.

The present inventors have realized that the above and other related problems are resolved by the present invention, and particularly by the use of a specifically reinforced smooth poly-fluorocarbon thermoplastic FEP, PTFE type tube material as used in various embodiments of the present invention. The present invention provides an FDA compliant hydrophobic smooth surface where foreign materials do not readily stick and can be easily and reliably cleaned unlike wavy convoluted poly-fluorocarbon thermoplastic liners or extruded silicone rubber tubes.

Plain, non-corrugated rubber covered industrial hoses are traditionally cured using a nylon shrink-wrap on the cover using open steam internal vulcanizer. This process imparts fabric impressions of the knitted/woven surface from nylon wrap on the rubber cover surface that provides small grids of peaks and valleys. Such surfaces are not easily cleanable and can potentially provide sites for bacteria, parasites and germs to reside and adhere. The smooth glossy, molded-like, cleanable outer rubber surface 10 free from corrugations as provided by this invention addresses above stated problem. Therefore, the present invention resolves the problem of cleaning and maintaining both internal as well as external surfaces of the hose free from contaminants, germs and bacteria.

The present inventors have realized that in service hose reliability issues from deformation of poly-fluorocarbon thermoplastic hose liner, and hose kink damage from flexing or coiling.

When hoses get bent or stretched and elongated due to increase in length of hose under operating working pressures, the poly-fluorocarbon thermoplastic liner can easily get stretched, kinked, warped and deformed causing recesses, folds, or crevices on the liner. This becomes evident when the hose is relaxed and not under pressure. These areas can entrap materials and are difficult to clean and are potential sites for bacteria and germs in a clean room environment making hose less reliable for sanitary safety requiring replacement.

Normally hoses get deformed permanently from over bending, as most hoses made from current known art require larger bend radii and are required to be removed from service with costs of disruption, replacement and down time to the end user.

The present invention provides a solution to the deformation and liner kinking problems by assuring that hose will not kink or stretch when coiled or bent very tightly in an application at smaller bend radii. The poly-fluorocarbon liner combined with the low modulus matrix and reinforcement pattern is designed for flexibility and linear stability under pressure. The innovative design of this hose in which textile reinforcements are applied at an approx. 45 degree or less (43 to 45 degree range) angle to the hoop force vertical direction assures that the hose will not significantly elongate and stretch under pressure and cause kinks or folds in the liner when pressure is released. This hose design offsets the normal elongation under pressure experienced in hoses especially with helical wire required for suction capability where such wires act like spring and contribute to greater hose elongation. Likewise the design parameters used for supporting the poly-fluorocarbon thermoplastic liner with embedded dual helical wires relatively smaller gauge, at smaller pitch in a low modulus, homogeneous body of the hose serves to prevent kinks in the hose substrate when it is bent to specified minimum bend radii which can be much smaller (2 to 5× inside hose dia) than current state of the art available hose products, which typically range from 4-10× inside dia. Therefore, the present invention solves the problem of kinking or coiling at smaller radii resulting in enhanced life and lower costs to consumer.

The present inventors have also realized savings and advantages in space constrained applications. In many tight space applications, traditional poly-fluorocarbon thermoplastic type hoses are difficult to use due to larger required bend radii to prevent such stiff hoses from kinking and damaging when routed in applications requiring smaller bend radii due to awkward configurations of equipment and availability of space. Similar kinking occurs when such hoses are coiled to smaller radii for storage or shipping.

However, the present invention solves or minimizes such problems by providing a solution because of extreme flexibility for routing in tight areas and non-kinking properties possible from the present invention, which can utilize available space more efficiently.

The present invention provides advantages in reducing turbulent flow or other problems that reduce flow of materials through the tube. As described earlier most of the hoses currently offered to this industry either have convoluted poly-fluorocarbon thermoplastic tube or smoother silicone rubber tube. Convoluted poly-fluorocarbon thermoplastic tube causes turbulent flow resulting in reduced flow and larger pressure drops. Smooth rubber tube hoses have higher coefficient of friction that also contributes to reduce flow due to frictional drag.

The smooth poly-fluorocarbon thermoplastic tube used in the present invention provides a very low coefficient of friction; resulting in a non-turbulent, drag free, increased laminar flow all of which solve such current industry flow problems with greater efficiencies.

The present inventors have also realized the need for efficient coupling and assembly reliability. Coupling of poly-fluorocarbon lined hoses pose special problems and challenges in producing reliable and safe assemblies. The slippery nature of the thermoplastic liners, especially if they are convoluted with reduced contact area and/or as outer corrugated surfaces of the hose both are problem areas in this regard specially when subjected to high pressures and elevated temperatures. Most applications require permanent type fittings which are either internally expanded type, swaged or crimped.

The present invention's smooth though somewhat slippery, thermoplastic liner in this hose in combination with smooth (non-corrugated) rubber outer cover provides surface conditions where the above noted permanent type fittings can be employed to produce safe and reliable assemblies.

Buying appeal to the customer generally lies in the appearance and cosmetics of the products. Even though hoses of the present invention are an industrial product, they are no exception. Most 100% thermoplastic hoses generally have good appearance with molded and smooth finish. However hybrid thermoplastic hoses that may have good tube appearance has the problem of dull appearance on the outside of the rubber cover due to the curing processes employed. Nylon wrapped hoses have fabric like impressions on the hose with or without corrugated shape all of which interferes with aesthetics including waviness in the transfer brands. Other surfaces show dull finish from open steam cures and or blooming of curatives, which migrate to the cover surface.

The process used in curing hoses of the present invention is more refined and does not result in the nylon fabric impression. Thermo shrinkage of an applied smooth film (e.g. Dartek Nylon R404 or easy release coated polypropylene and other similar shrinkable materials) is obtained for the cure in a similar fashion as the nylon fabric, but leaves a shiny, glossy, molded finish imparted to the cover surface which greatly enhances the cosmetic appeal of the hose. In combination with a bright standard organic color or a fluorescent color which may be the type which glows in the dark (and/or Day Glo) provides for easy identification and location of the hoses. This hose thus provides great cosmetic appeal.

The present inventors have realized the importance of product initial and replacement costs. Industrial market requires hose applications at minimal cost to the customers. This includes initial high cost to fabricate and install hose assemblies and subsequent costs of replacement of product failures, costs of disruption, downtime and loss of productivity, costs associated with product liability in case of failures for injuries and/or fines that may be imposed on the end user. Product cost therefore becomes a very important factor in acceptability of hose and hose assemblies in the market place.

The present invention provides initial reduced cost of hose, the reliability of assemblies made from this hose, minimal downtime and productivity or replacement costs, much reduced chances of hose kink damage from bending hose are all important benefits derived from this invention which is beneficial to the customers and end users.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing an EPDM composition, any other equivalent material, such as other low modulus compounds, or other materials having an equivalent capability, whether or not listed herein, may be substituted therewith. Furthermore, the inventors recognize that newly developed technologies not now known may also be substituted for the described parts and still not depart from the scope of the present invention. All other described items, including, but not limited to yarns, wires, smooth films, etc should also be consider in light of any and all available equivalents.

The present invention may suitably comprise, consist of, or consist essentially of, any of element (the various parts or features of the invention and their equivalents. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed is:

1. A hose comprising:
a thermoplastic liner;
an elastic backing substrate applied to the thermoplastic liner;
a first reinforcement line wrapped around and at least partly embedded in the backing substrate;
a filler layer disposed over the reinforcement line and molded into the elastic backing substrate;
a second reinforcement line wrapped over the filler layer and at least partly embedded in the filler layer;
a wire reinforcement line wrapped over the second reinforcement line; and
a cover material disposed over the second embodiment line and molded into the filter layer;
wherein the cover material has a smooth, non-porous, outside surface.

2. The hose according to claim 1 wherein the first reinforcement line is a polyester yarn.

3. The hose according to claim 2 wherein the second reinforcement line is a polyester yarn.

4. The hose according to claim 1 wherein the wire comprises a carbon steel wire.

5. The hose according to claim 1 wherein the wire comprises one of a carbon steel wire, stainless steel wire, monofilament rod, and similar materials.

6. The hose according to claim 1 wherein the wire reinforcement line is a dual helical small gauge wire of approximately 0.041″ to 0.080″ in diameter.

7. The hose according to claim 6 wherein the dual helical small gauge wire is configured at an optimal pitch comprising a spacing between wire of:

| Hose Diameter | Wire Gauge | Pitch | No. of | Space Between |
|---|---|---|---|---|
| (in) | (in) | (in) | Wires | Adjoining Wires |
| 0.5 | 0.041 | 0.300-0.400 | 2 | 0.150-0.200 |
| 0.75 | 0.041 | 0.300-0.400 | 2 | 0.150-0.200 |
| 1 | 0.041 | 0.300-0.400 | 2 | 0.150-0.200 |
| 1.25 | 0.041 | 0.300-0.400 | 2 | 0.150-0.200 |
| 1.5 | 0.048 | 0.360-0.640 | 2 | 0.180-0.320 |
| 2 | 0.062 | 0.360-0.640 | 2 | 0.180-0.320 |
| 2.5 | 0.062 | 0.360-0.640 | 2 | 0.180-0.320 |
| 3 | 0.080 | 0.500-0.600 | 2 | 0.250-0.300 |
| 4 | 0.092 | 0.500-0.600 | 2 | 0.250-0.300 |

8. The hose according to claim 1 wherein:
the first reinforcement line is wrapped at a first angle of lay; and the second reinforcement line is wrapped at a second angle of lay opposite the first angle of lay.

9. The hose according to claim 1 wherein:
the first reinforcement line is wrapped at a first angle of lay; and
the second reinforcement line is wrapped at a second angle of lay that is approximately 90 degrees with respect to the first angle of lay.

10. The hose according to claim 1 wherein:
The first reinforcement line wrapped at approximately a +45 degree of angle of lay;
and the second reinforcement line is wrapped at approximately a −45 degree angle of lay.

11. The hose according to claim 1, wherein:
the first reinforcement line and the second reinforcement line are wrapped at an optimal angle comprising 43-45 degrees.

12. The hose according to claim 1 wherein the first and second reinforcement lines are textile reinforcement lines, and the wire reinforcement line has a space between lines of approximately 0.150 and 0.300 inches.

13. The hose according to claim 1, wherein the thermoplastic liner is a polyfluorocarbon thermoplastic liner having a thin walled construction of approximately 0.08 in to 0.020 in of wall thickness.

14. The hose according to claim 1 wherein the elastic backing substrate comprises an adhesive.

15. The hose according to claim 14 wherein the elastic backing substrate comprises a peroxide cured EPDM based adhesive.

16. The hose according to claim 1 wherein the elastic backing adhesive substrate and filler layer comprise a low modulus component.

17. The hose according to claim 1 wherein the elastic backing substrate and filler layer comprise a low modulus rubber compound.

18. The hose according to claim 1 wherein the first reinforcement line and the second reinforcement line have variable pitches based on a hose diameter.

19. The hose according to claim 1 wherein the hose elastomeric components yield a modulus of 150-300 lbs tensile strength at 100% elongation.

20. The hose according to claim 1 wherein the hose has a bend radii, approximately comprising:

| Hose Dia. | |
|---|---|
| (in) | MBR |
| ½ | 2 X Hose ID |
| ¾ | 2 X Hose ID |
| 1 | 2.5 X Hose ID |
| 1¼ | 3 X Hose ID |
| 1½ | 3 X Hose ID |
| 2 | 3 X Hose ID |
| 2½ | 4 X Hose ID |
| 3 | 4 X Hose ID |
| 4 | 5 X Hose ID |
